(19) United States
(12) Patent Application Publication
(10) Pub. No.: US 2010/0121905 A1
(43) Pub. Date: May 13, 2010

(54) Visual Content Detection for Computer-Delivered Advertisement Exposure Measurements

(76) Inventors: Thomas R. McKnight, Ellicott City, MD (US); Lee S. Weinblatt, Teaneck, NJ (US)

Correspondence Address: PROSKAUER ROSE LLP, ONE INTERNATIONAL PLACE, BOSTON, MA, 02110, US

(21) Appl. No.: 12/605,881

(22) Filed: Oct. 26, 2009

Related U.S. Application Data
(60) Provisional application No. 61/108,401, filed on Oct. 24, 2008.

(51) Int. Cl. G06F 15/16

(52) U.S. Cl. 709/202

(57) ABSTRACT

Described are a method, a computer program product and apparatus for detecting visual display of content. Visual content data encoded with an identifier code is received at a computer device. Visual display data is transmitted, using a local communication bus of the computer device, to a visual display device coupled to the computer device. A processor on the computer device is used to determine whether the visual display data includes the encoded identifier code. Exposure information is generated using the processor. The exposure information is associated with whether the encoded identifier code is included in the visual display data. The exposure information is transmitted, from the computer device, to a remote server device.

### RELATED APPLICATIONS

This application claims priority to and the benefit of U.S. Provisional Patent Application No. 61/108,401, filed on Oct. 24, 2008, the entire contents of which are incorporated herein by reference.

### FIELD OF THE INVENTION

The present invention relates to a computer-implemented method, a computer program product and an apparatus for measuring exposure to image and video content, including advertisements.

### BACKGROUND

Advertisements are increasingly being delivered onto personal computers in the form of both video content and static images. Many techniques used in the measurement of individual exposure to computer-delivered content make use of features built into web browsers that recognize external tags associated with the content as part of the web-based content delivery. These tags (e.g., “cookies”) are typically stored on the user's computer by the computer's web browser, and can later be used for a variety of purposes, including the measurement of advertising exposure. When a web browser pulls content from a web site, it makes a record of the individual tagged items which were used to make up the web page and stores this on the computer's hard drive. This information can then be collected from individual web browsers to form an indication of exposure to a specific advertisement from amongst the population of browsers polled. This technique does not measure whether the visual content was actually delivered to the computer's screen (as can happen when a browser window is minimized, or when a portion of a web page is scrolled off-screen) and does not provide any indication whatsoever of the length of time that the advertisement was actually being presented to the viewer. Further, this technique does not work for certain forms of embedded web content, and does not work at all for content that is not displayed using a web browser (such as stored videos played on media viewers).

### SUMMARY OF THE INVENTION

One approach to measuring advertisement exposure of visual content is to encode and decode the visual content with an identifier code. The invention, in one aspect, features a computer-implemented method for detecting visual display of content. The computer-implemented method includes receiving, at a computer device, visual content data encoded with an identifier code. The computer-implemented method also includes transmitting, using a local communication bus of the computer device, visual display data to a visual display device coupled to the computer device. The computer-implemented method also includes determining, using a processor on the computer device, whether the visual display data includes the encoded identifier code. The computer-implemented method also includes generating, using the processor, exposure information associated with whether the encoded identifier code is included in the visual display data. The computer-implemented method also includes transmitting, from the computer device, the exposure information to a remote server device.

In another aspect, there is a computer program product, tangibly embodied in a machine-readable storage device. The computer program product includes instructions being operable to cause a data processing apparatus to receive, at the data processing apparatus, visual content data encoded with an identifier code. The computer program product further includes instructions being operable to cause a data processing apparatus to transmit, using a local communication bus of the data processing apparatus, visual display data to a visual display device coupled to the data processing apparatus. The computer program product further includes instructions being operable to cause a data processing apparatus to determine, using a processor on the data processing apparatus, whether the visual display data includes the encoded identifier code. The computer program product further includes instructions being operable to cause a data processing apparatus to generate, using the processor, exposure information associated with whether the encoded identifier code is included in the visual display data. The computer program product further includes instructions being operable to cause a data processing apparatus to transmit, from the data processing apparatus, the exposure information to a remote server device.

In another aspect, there is a system for detecting visual display of content. The system includes a central processing unit configured to receive visual content data encoded with an identifier code. The central processing unit is also configured to determine whether visual display data includes the encoded identifier code. The central processing unit is also configured to generate exposure information associated with whether the encoded identifier code is included in the visual display data. The central processing unit is also configured to transmit the exposure information to a remote server device. The system also includes a local communication bus, coupled to the central processing unit, configured to transmit the visual display data to a visual display device.

In another aspect, there is a system for detecting visual display of content. The system includes a processing unit configured to receive, from a local communication bus of a computer device, visual display data. The processing unit is also configured to determine whether the visual display data includes visual content data encoded with an identifier code. The processing unit is also configured to generate exposure information associated with whether the encoded identifier code is included in the visual display data. The processing unit is also configured to transmit, from the first computer device, the exposure information to a remote server device.

In other examples, any of the aspects above can include one or more of the following features. In some embodiments, the processor includes a central processing unit of the computer device. In other embodiments, the processor is coupled to the local communication bus and is different from a central processing unit of the computer device. The visual display data can include the visual content data encoded with the identifier code. The visual display data can be generated to include the visual content data by a software application executing on a central processing unit of the computer device. The software application can include a web-based browser application, a video-streaming application, a video-player application, a game application, or any combination thereof. The visual content data can include static images, animated images, video data, or any combination thereof The visual content data can be received from the Internet. The exposure information can include size information associated with the size of the visual content data in the visual display data, timing information associated with a length of time that the visual content data is included in the visual data, or any combination thereof.

Any of the above implementations can realize one or more of the following advantages. The actual display of the visual content data on a visual display device, such as a computer screen, can advantageously be determined, as opposed to the visual content data being located in a portion of a display window (e.g., web page) that was never scrolled to, or within a minimized display window. The ability to measure the exposure of visual content can advantageously be performed independent of what software application is used to generate or control that the visual display include the visual content data. In some embodiments, measuring visual content exposure can be performed for visual content controlled by browser-based applications and/or non-browser based applications, such as, for example, movie players (streaming or download) and game applications. The size at which the visual content data is displayed (as this can vary depending on how the user has arranged individual application windows) can advantageously be determined. The length of time that the visual content data is displayed can advantageously be determined.

Previous systems and techniques used to measure advertising delivered by computer only report on ads downloaded to a computer and do not take into account ads that actually get displayed on screen. Other techniques rely on tracking pages that are visited, and whether there is tagged advertising somewhere on those pages. For example, if an Internet page containing a news story with advertising content is visited, the browser records that the page was visited, and reports all of the tagged advertising content associated with that page. With this technique, there is no way to know what portion of the page that was actually displayed on-screen, and whether or how long any of the ads appeared on-screen.

Other aspects, examples, and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other features and advantages of the present invention, as well as the invention itself, will be more fully understood from the following description of various embodiments, when read together with the accompanying drawings.

FIG. 1 is a block diagram illustrating a computer device for decoding of visual content data.

FIG. 2 is a flow diagram illustrating encoding and decoding of visual content data.

### DETAILED DESCRIPTION

The invention makes use of an encoder/decoder system whereby visual content data (e.g., static images, animated images, video data, and/or other visual content data) is encoded with an identifier code. For example, visual content data can be encoded with a mark using digital image watermarking. In some embodiments, the identifier code is encoded in a manner that minimizes its visual appearance to the human eye, but still allows the identifier code to be detected by software and/or hardware.

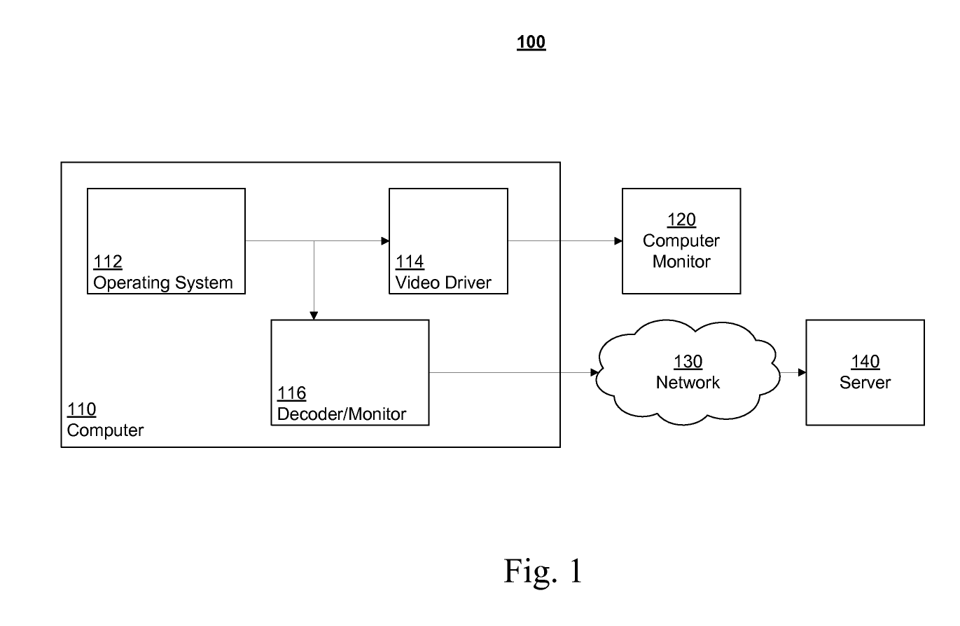

FIG. 1 is a block diagram showing an exemplary system 100 with devices relating to decoding visual content. The system 100 includes a computer device 110, a visual display device 120, a network 130, and a server 140. The computer device 110 can include an operating system 112, a video driver 114, and/or a decoder/monitor 116. In some embodiments, the computer device 110 can include a personal computer (e.g., desktop or laptop) or a mobile communications device with a display (e.g., a cell phone, smartphone, and/or the like). The operating system 112 can be implemented on a central processing unit of the computer device 110. In some embodiments, the video driver 114 can include a video controller embedded on a motherboard. In alternative or supplemental embodiments, the video driver 114 can include a video card. The video driver 114 can be coupled to the operating system 112 using a local communication bus that transmits visual display data for display on the visual display device 120.

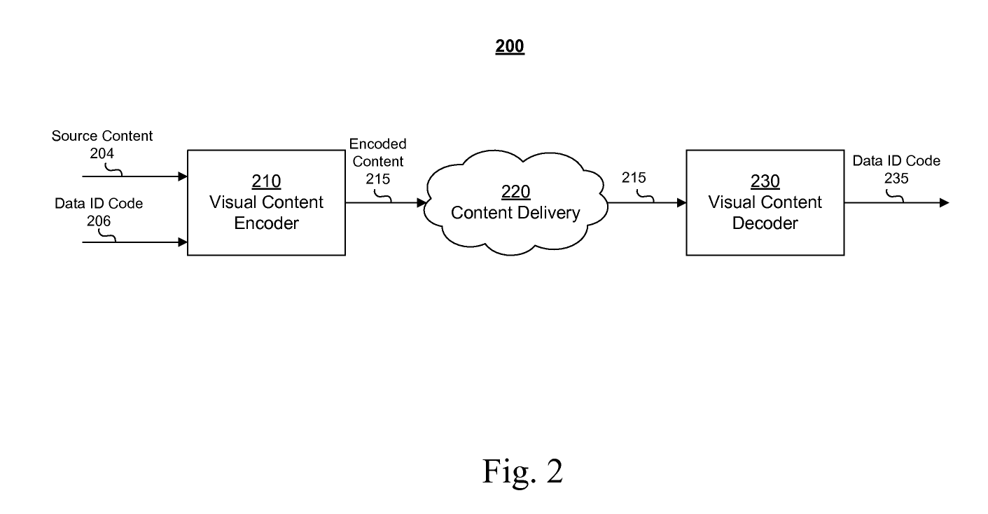

FIG. 2 illustrates a flowchart 200 depicting an implementation of encoding video and/or image content. The implementation includes encoding source content 204 with a data identifier code 206 (210), delivering the encoded content 215 (220), and decoding the content to obtain the data identifier code 235 (230). The visual content data can be incorporated into visual display data by the computer device 110 for display onto the display device 120. The data identifier code 235 can accurately be decoded from the visual display data regardless of any re-sizing of the source visual content data and/or regardless of changes in resolution of the visual content data. In addition, in some embodiments, the data identifier code can be detected even if the source visual content is combined with other visual content, such as is the case on a computer-based delivery system where the coded visual source content is possibly a portion of the visual display data (e.g., a composite image).

The detector/monitor 116 can be implemented as hardware and/or software on a processing unit separate from the central processing unit (e.g., the operating system 112) of the computer device 110. In this case, the processor that implements function(s) of the detector/monitor 116 can be coupled to the same local communication bus that is used to transmit visual display data to the video driver 114. In alternative or supplemental embodiments, the detector/monitor 116 can be implemented as hardware and/or software on the central processing unit (e.g., the operating system 112) of the computer device 110. In yet further alternative or supplemental embodiments, the detector/monitor 116 can be implemented as hardware and/or software on a processing unit external to the computer device 110, where the processing unit has access to the visual display data transmitted to the video driver 114 and/or the visual display device 120

The detector/monitor 116 can be configured to listen into data transaction(s) between the operating system 112 and the video driver 114. In this way, the detector/monitor 116 can advantageously function independently of the software application used to generate the visual content/display. The detector/monitor 116 can report detection of encoded content if the encoded identifier is actually transmitted for display on the display or monitor 120, and does not report detection if the visual content data is, from the perspective of the operating system 112, located within a window that is minimized or covered up by another window. In some embodiments, the detector/monitor 116 can continuously monitor and process all of the visual display data that is written out by the operating system 112 to the video driver 114.

The detector/monitor 116 can also provide continuous monitoring of the time and/or duration of exposure of the visual content data, even for static images. Also, in some embodiments, the detection process can include a measurement of the size and/or resolution that the source visual content data was displayed at. In summary, if a user of the computer device 110 can see encoded visual display data (e.g., including encoded visual content data as an image and/or video) on the display device 120, then the detector/monitor 116 can detect the display of the visual content data. If the user cannot see the encoded visual content data on the display device 120 (e.g., because the encoded visual content data is at the bottom of a web page and the user has not scrolled to the bottom of the webpage), then the detector/monitor 116 can prevent a false detection report of the visual content data from being created.

In some embodiments, the system 100 can be applied to any visual content data delivered to the display device 120. For example, visual content data can include Internet-delivered advertising, ads embedded in video games, downloaded and/or streaming movies, and/or any other application used to display content with advertising. Visual content data can be encoded in a way that minimizes visibility to the human eyes.

In the case of computer-delivered content, the computer device 110 can be a personal computer and the decoder 116 can be in the form of a software application that resides on the personal computer. The software application can monitor all visual display data sent out to the computer's video monitor and analyze that data to detect and/or decode any portion of the visual field which is displayed on the computer screen. The decoder/monitor 116 can then transmit exposure information over the network 130 (e.g., the Internet) a server 140. The server 140 can be a central computer that stores the exposure information. The server 140 can combine the exposure information received from one or more other computer devices (not shown) connected to one or more other networks.

In some embodiments, the decoder/monitor 116 can identify an individual that is exposed to visual content. For example, the computer device 110 can be a portable wireless device carried by an individual that can communicate identification information to the decoder/monitor 116. The decoder/monitor 116 can then associate the individual with the detected visual content data.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry® or an iPhone®.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computer-implemented method for detecting visual display of content, the computer-implemented method comprising:
receiving, at a computer device, visual content data encoded with an identifier code;
transmitting, using a local communication bus of the computer device, visual display data to a visual display device coupled to the computer device;
determining, using a processor on the computer device, whether the visual display data includes the encoded identifier code;
generating, using the processor, exposure information associated with whether the encoded identifier code is included in the visual display data; and
transmitting, from the computer device, the exposure information to a remote server device.

2. The computer-implemented method of claim 1, wherein the processor comprises a central processing unit of the computer device.

3. The computer-implemented method of claim 1, wherein the processor is coupled to the local communication bus and is different from a central processing unit of the computer device.

4. The computer-implemented method of claim 1, wherein the visual display data includes the visual content data encoded with the identifier code.

5. The computer-implemented method of claim 4, wherein the visual display data is generated to include the visual content data by a software application executing on a central processing unit of the computer device.

6. The computer-implemented method of claim 5, wherein the software application comprises a web-based browser application, a video-streaming application, a video-player application, a game application, or any combination thereof.

7. The computer-implemented method of claim 1, wherein the visual content data comprises static images, animated images, video data, or any combination thereof.

8. The computer-implemented method of claim 1, wherein the visual content data is received from the Internet.

9. The computer-implemented method of claim 1, wherein the exposure information includes size information associated with the size of the visual content data in the visual display data, timing information associated with a length of time that the visual content data is included in the visual data, or any combination thereof.

10. A computer program product, tangibly embodied in a machine-readable storage device, the computer program product including instructions being operable to cause a data processing apparatus to:
receive, at the data processing apparatus, visual content data encoded with an identifier code;
transmit, using a local communication bus of the data processing apparatus, visual display data to a visual display device coupled to the data processing apparatus;
determine, using a processor on the data processing apparatus, whether the visual display data includes the encoded identifier code;
generate, using the processor, exposure information associated with whether the encoded identifier code is included in the visual display data; and
transmit, from the data processing apparatus, the exposure information to a remote server device.

11. A system for detecting visual display of content, the system comprising:
a central processing unit configured to:
receive visual content data encoded with an identifier code;
determine whether visual display data includes the encoded identifier code;
generate exposure information associated with whether the encoded identifier code is included in the visual display data;
transmit the exposure information to a remote server device; and
a local communication bus, coupled to the central processing unit, configured to transmit the visual display data to a visual display device.

12. A system for detecting visual display of content, the system comprising:
a processing unit configured to:
receive, from a local communication bus of a computer device, visual display data;
determine whether the visual display data includes visual content data encoded with an identifier code;
generate exposure information associated with whether the encoded identifier code is included in the visual display data; and
transmit, from the first computer device, the exposure information to a remote server device.
